(19) United States
(12) Patent Application Publication
(10) Pub. No.: US 2004/0012643 A1
(43) Pub. Date: Jan. 22, 2004

(54) Systems and methods for visually communicating the meaning of information to the hearing impaired

(76) Inventors: Katherine G. August, Matawan, NJ (US); Daniel D. Lee, Leonia, NJ (US); Michael Potmesil, Aberdeen, NJ (US)

Correspondence Address: John E. Curtin, Esq., Troutman Sanders LLP, Suite 1600, 1660 International Drive, McLean, VA, 22102, US

(21) Appl. No.: 10/197,470

(22) Filed: Jul. 18, 2002

(51) Int. Cl. G09G 5/00

(52) U.S. Cl. 345/865; 345/827

(57) ABSTRACT

The present invention provides systems and methods for visually communicating the meaning of information to the hearing impaired by associating written or spoken language to sign language animations. Such systems comprise associating textual or audio symbols with known sign language symbols. New sign language symbols can also be generated in response to information which does not have a known sign language symbol. The information can be treated as elements which can be weighted according to each element's contribution to the overall meaning of the information sought to be communicated. Such systems can graphically display representations of both known and new sign language symbols to a hearing impaired person.

### TECHNICAL FIELD

This invention relates to systems and methods for visually communicating the meaning of information to the hearing impaired.

### BACKGROUND OF THE INVENTION

Hearing impaired individuals who communicate using sign language, such as American Sign Language (ASL), Signed English (SE), or another conventional language must often rely on reading subtitles or other representations of spoken language during the performance of plays, while watching television, in theater productions, lectures, and during telephone conversations with hearing people. Conversely, hearing people, in general, are not familiar with sign language.

When it comes to communicating using a telephone, there exists technology to assist hearing impaired persons make telephone calls. For example, telecommunication devices for the deaf (TDD), text telephone (TT) or teletype (TTY) are just a few that come to mind. Modern TDDs permit the user to type characters into a keyboard. The character strings are then encoded and transmitted over a telephone line to a display of a remote TDD device.

Systems have been developed to facilitate the exchange of telephone communications between the hearing impaired and hearing users including a voice-to-TDD system in which an operator, referred to as a “call assistant,” serves as a human intermediary between a hearing person and a hearing impaired person. The call assistant communicates by voice with the hearing person and also has access to a TDD device or the like for communicating textual translations to a hearing impaired person. After the assistant receives text via the TDD from the hearing impaired person, the assistant can read the text aloud to the hearing person. Unfortunately, TDD devices and the like are not practical for watching television, attending theater or lectures, and impromptu meetings.

Therefore, there is a need for improved systems and methods for communicating the meaning of information to the hearing impaired.

### SUMMARY OF THE INVENTION

The present invention provides techniques for visually communicating information to the hearing impaired, one of which comprises an association unit adapted to associate an information element with its known sign language symbol, and generate a new sign language symbol for each element not associated with a known sign language symbol. Additionally, each element not associated with a known sign language symbol may be weighted according to its contribution to the overall meaning of the information to be communicated. One aspect of the invention associates the meaning of a string of information as a whole, rather than associate each element individually. Thus, the present invention can convey meaning without being limited to a one-to-one, element-to-symbol translation.

Other features of the present invention will become apparent upon reading the following detailed description of the invention, taken in conjunction with the accompanying drawings and appended claims.

### BRIEF DESCRIPTION OF THE DRAWINGS

FIG. 1 is a simplified block diagram of a system for visually communicating the meaning of information to the hearing impaired according to one embodiment of the present invention.

FIG. 2 is a simplified block diagram of a system for visually communicating the meaning of information to the hearing impaired according to an alternative embodiment of the present invention.

FIG. 3 is a simplified flow diagram depicting a method of visually communicating the meaning of information to the hearing impaired according to one embodiment of the present invention.

FIG. 4 is a simplified flow diagram depicting a method of creating new sign language symbols for information having no known sign language equivalent according to one embodiment of the present invention.

### DETAILED DESCRIPTION OF THE INVENTION

Referring now to the drawings, in which like numerals refer to like parts or actions throughout the several views, exemplary embodiments of the present invention are described.

It should be understood that when the terms “sign language” are used herein, these terms are intended to comprise visual, graphical, video and the like translations of information made according to the conventions of the American Sign Language (ASL), Signed English (SE), or other sign language system (e.g., finger spelling).

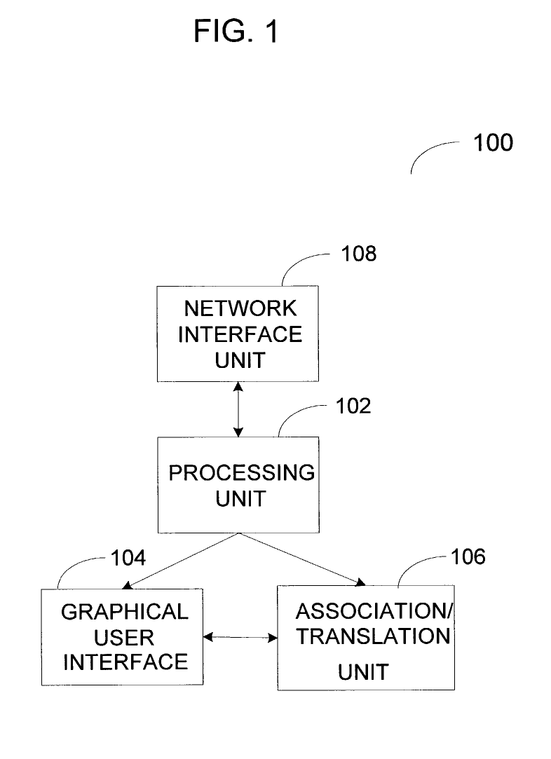

FIG. 1 shows a system 100 adapted to translate information into sign language. System 100 comprises processing unit 102, graphical user interface 104, association/translational unit 106 (collectively referred to as “association unit”) and network interface unit 108. System 100 may comprise a computer, handheld device, personal data assistant, wireless device (e.g., cellular or satellite telephone) or other devices. The information translated may originally comprise textual, graphical, voice, audio, or visual information having a meaning intended to be conveyed. The information may comprise coded or encrypted elements and can be broken down into other types of elements, such as alphabetical characters, words, phrases, sentences, paragraphs or symbols. These elements in turn can be combined to convey information.

Processing unit 102 is adapted to process information using, for example, program code which is embedded in the unit or which has been downloaded locally or remotely. Processing unit 102 is operatively connected to graphical user interface 104.

Graphical user interface 104 may comprise windows, pull-down menus, scroll bars, iconic images, and the like and can be adapted to output multimedia (e.g., some combination of sounds, video and/or motion). Graphical user interface 104 may also comprise input and output devices including but not limited to, microphones, mice, trackballs, light pens, keyboards, touch screens, display screens, printers, speakers and the like.

In one embodiment of the present invention, the association unit 106 is adapted to associate information sought to be communicated to the hearing impaired with known sign language symbols or representations (hereafter collectively referred to as “symbols”), etc. to convey the meaning of the information. The association unit 106 is further adapted to associate parts of any language including, but not limited to: English, Japanese, French, Spanish etc. . . . with the equivalent sign language symbols. Individual information elements or groups of elements can be associated with their equivalent sign language symbol. Elements not associated with a known sign language symbol can be animated (e.g., using finger spelling). The system 100 can associate each element with a sign language symbol or associate the meaning of a string of elements with at least one sign language symbol.

Network interface unit 108 is adapted to connect system 100 to one or more networks, such as the Internet, an intranet, local area network, or wide area network allowing system 100 to be accessed via standard web browsers. Network interface unit 108 may comprise a transceiver for receiving and transmitting electromagnetic signals (e.g., radio and microwave).

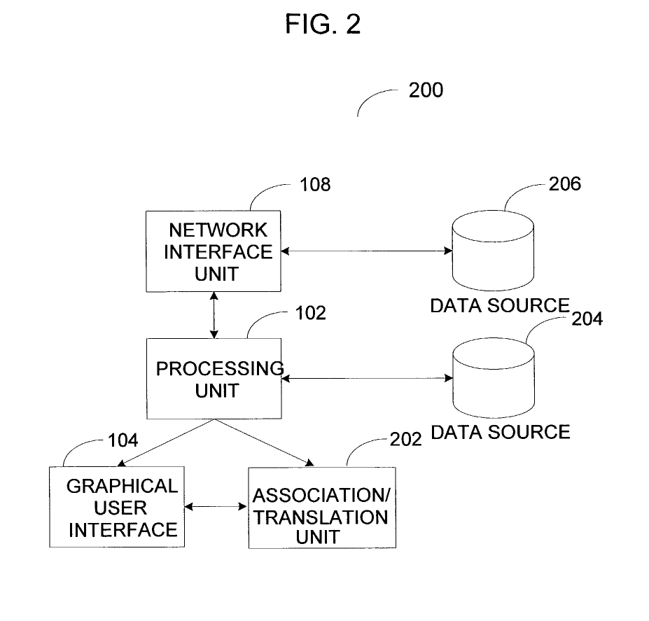

Referring now to FIG. 2, system 200 comprises components of system 100 as well as additional components. As shown, system 200 comprises association unit 202 adapted to translate textual information into sign language symbols by matching text to equivalent sign language graphical symbols. The text can be in any form including, but not limited to: electronic files, playscripts, Closed Captioning, TDD, or speech which has been converted to text. Known graphical symbols can be stored within a local database 204 or can be retrieved from a remote database 206. System 200, via interface 104, can be adapted to display such graphical sign language symbols, etc. . . . as animation or video displays. Remote database 206 can be accessed using the network interface unit 108 which, for example, may be part of a cellular telephone or an Internet connection.

Alternatively, system 200 may be adapted to receive audio information (e.g., speech) and convert the audio information into text or into equivalent sign language symbols.

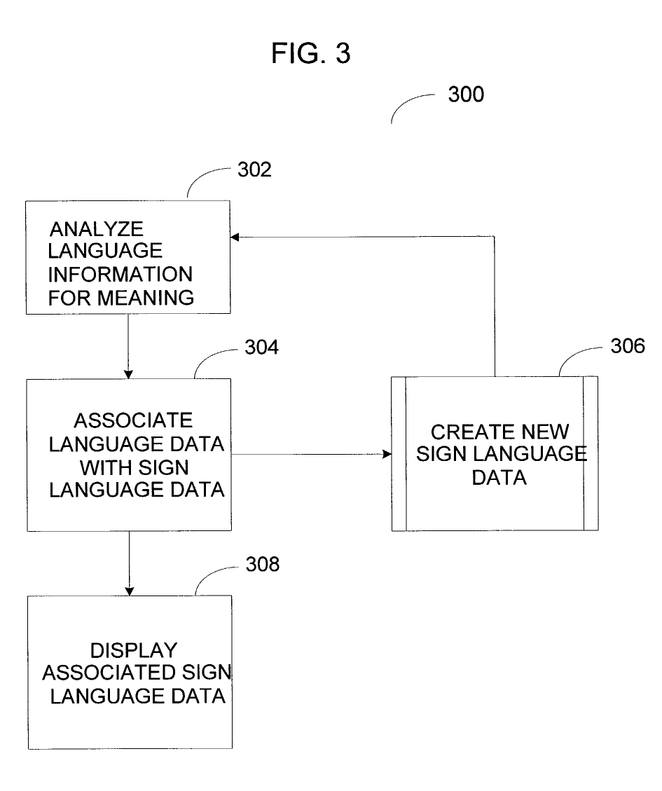

Exemplary systems 100 and 200 (collectively “the systems”) can associate information with sign language symbols, preferably sign language animations, using the exemplary process 300 described in FIG. 3.

Systems 100,200 can receive language information using any conventional communication means. Once the information is received, a system is adapted to analyze the information for its meaning in step 302. Such an analysis can make use of adaptive learning techniques. In particular, exemplary systems 100,200 are adapted to determine the appropriate meaning of an element (including when an element has multiple meanings) depending on the context and use of the element. For example, the word “lead” can refer to a metal or to an active verb meaning “to direct”.

Processing unit 102, or association unit 202, can be adapted to analyze each element of information to determine the element's contribution to the overall meaning of the information. In one embodiment, processing unit 102, or association unit 202, is adapted to associate each element with a “weight” (i.e., a value or score) according to the element's contribution.

In another embodiment, the systems of the present invention monitor the frequency, presence, and use of each element. When an element that can have multiple meanings is encountered, systems envisioned by the present invention are adapted to perform a probability analysis which associates a probability with each meaning in order to indicate the likelihood that a specific meaning should be used. Such an analysis can analyze the elements used in context with ambiguous elements and determine the presence or frequency of particular elements. Those frequencies, etc. . . . can influence whether a particular meaning should be used for the ambiguous element. For example, if the ambiguous element is “lead” and the system identifies words such as “gold, silver, or metal” in a string of characters near “lead”, systems envisioned by the present invention are adapted to determine that the definition of lead as a metal should be used. Additionally, systems envisioned by the present invention are adapted to determine whether the ambiguous element is used as a noun, verb, adjective, adverb etc. . . . and factor the use of the ambiguous element into the probability analysis. Thus, if a system determines that “lead” is used as a noun, it can additionally be adapted to determine that it is more likely than not that the element refers to a metal rather than to the verb meaning “to direct”.

Another embodiment of the present invention provides a system adapted to determine the gender of a proper noun by determining the frequency of gender specific pronouns in a string of characters near or relating to the proper noun. Thus, if pronouns such as “his”, “him”, or “he” are used near the proper noun, the system is adapted to determine that the proper noun is probably male.

Systems envisioned by the present invention can also be adapted to translate the overall tone or meaning of a string of elements. For example, a system can be adapted to generate animations comprising sign language wherein the position of the signing conveys a meaning in addition to the actual sign. Positioning of signing can be used to refer to multiple speakers in a conversation. For example, if the hearing impaired person is communicating with two other individuals, signs in the lower left quadrant can be intended for one individual, while signs in the upper right quadrant can be intended for another individual. Thus, symbol positioning can be used to convey meaning. The speed of the signing can also convey meaning such as urgency or the like.

Referring back to FIG. 3, in step 304, an association unit 106 is adapted to associate elements which contribute to the meaning of the information with sign language symbols having a corresponding meaning. The sign language symbols and weights can be stored and accessed via database 204 or remote database 206. Elements having a contribution value below a set threshold value will not be associated with a symbol. For example, indefinite articles such as “the” or “a” may be assigned a low contribution value depending how the articles are used and will not be translated each time the system encounters them.

In the event an element cannot be associated with a known symbol, systems envisioned by the present invention are adapted to generate a new symbol in step 306 to convey the meaning of the element. Association unit 202 or processing unit 102 can be adapted to generate a new sign language symbol and corresponding animation by parsing the information element into language root elements having known meanings. Language root elements can include Latin, French, German, Greek, and the like.

For example, if a system encounters the word “puerile” and puerile does not have a known sign language symbol, a processing unit or association unit can be adapted to parse the word puerile into its Latin root “puer.” Latin roots or other language roots can be stored in the system in conjunction with the meaning of the roots or sign language symbol associations linked to the roots. Once a system identifies the root and the root's meaning, it can be adapted to attempt to locate a sign language symbol having a similar or related meaning. In this case, puer means boy or child, and the system can be adapted to associate the word “puerile” with a sign language symbol associated with the word “child” or one which means “childlike.” Using grammar algorithms or software, the system can be adapted to identify whether the information element is a noun, verb, adjective, adverb or the like and associate a sign language symbol accordingly.

Alternatively, systems envisioned by the present invention may comprise a directory of sign language symbol associations linked to multiple information elements, including known words or roots that have identical, similar, or related meanings. Each link can be structured in a hierarchy depending on how close the meaning of the symbol approximates the meaning of the associated element, word or root. Such systems can be adapted to provide users with a menu of symbol options that can be associated with an unknown word or information element by first presenting the user with a symbol having the greatest similarity in meaning followed by symbols with lower associated meaning. Systems envisioned by the present invention can also be adapted to present a group of symbols extrapolated from root elements of a string of information elements, the combination of symbols together representing the meaning of the string of information elements. Association units envisioned by the present invention can be adapted to generate a new sign language symbol for each element not associated with a known sign language symbol, wherein each element not associated with a known sign language symbol is weighted according to its contribution to the overall meaning of the information to be communicated.

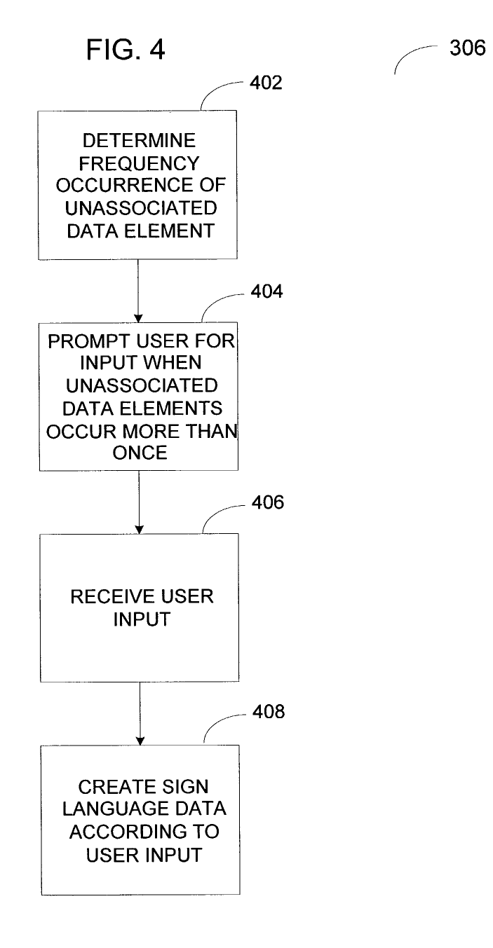

FIG. 4 shows an exemplary flow diagram of step 306 broken down into steps 402-408.

When an association unit determines an element has no known associated sign language symbol that can be used to convey the meaning of the element, systems envisioned by the present invention are adapted to monitor the frequency at which such elements are received in step 402. Next, in step 404 systems envisioned by the present invention can prompt a user for instructions, such as whether or not to create a new symbol. Such systems can be adapted to receive user input in step 406 and, optionally may create new sign language symbols in step 408 based on the input. The symbols created in step 408 can be graphical symbols such as pictures or diagrams. Alternatively, the symbols can be animations. Systems envisioned by the present invention can be adapted to determine whether information elements input by a user should be grouped together because they are needed in combination to represent the correct meaning, (e.g., a phrase) in which case one symbol may suffice, or whether each element or group of elements can stand alone, in which case a new symbol for each element or group of elements must be created.

It should be noted that individual information elements may be associated with more than one symbol because they may have more than one meaning. Said another way, a single element can be associated with different symbols depending on its meaning. It should also be understood that the meaning of an element can change depending on whether the element is grouped with other specific elements. For example, an element represented by the word “a” or “the” can have a different meaning than normal in limited circumstances. For instance when an “a” follows after “Mr.” to represent someone's initials it has a different meaning than normal, and, therefore, will be associated with a new sign language equivalent symbol.

Some words (e.g., text) that are known to indicate the gender of the speaker of text have no existing sign language equivalent symbol. For example, in a play's script, each character's dialog is identified with a character's name. In one embodiment of the present invention, each character's dialog is processed in a different manner. In more detail, systems envisioned by the present invention can be adapted to receive user input in step 406 and then may proceed to step 408 to create new sign language symbols based on the input. Such symbols may comprise graphics such as pictures or diagrams. Alternatively, the symbols can be animations. Systems are adapted to display a male avatar or animation for text associated with a male character, and a female avatar or animation for text associated with a female character. Likewise, children's voices can be represented by a display of an animated child of appropriate age, gender, etc.

In the case where systems envisioned by the present invention are connected to a computer or communications network, a user can provide a representation of himself or herself to be used in the avatar, or as the avatar. In such a case, the user is a typically a hearing person who does not known sign language. In one embodiment, the user can speak into a system, and the system can translate the spoken information into an animation of the user signing the information.

In another embodiment, Closed Captioning can be used as text to drive a “picture-in-picture” representation of the avatar signing along with the play/program. In yet another embodiment, animations can be synchronized with simultaneously running video, audio, etc. . . . Alternatively, the animations can be run asynchronously with other media, text, live presentations, or conversations.

Though the present invention has been described using the examples described above, it should be understood that variations and modifications can be made without departing from the spirit or scope of the present invention as defined by the claims which follow:

We claim:

1. A system for visually communicating information to the hearing impaired comprising:
an association unit adapted to:
associate each information element with its known sign language symbol; and
generate a new sign language symbol for each element not associated with a known sign language symbol, wherein each element not associated with a known sign language symbol is weighted according to its contribution to the overall meaning of the information to be communicated.

2. The system as in claim 1, further comprising a display adapted to depict the known and new sign language symbols.

3. The system of claim 1, wherein the known and new sign language symbols comprise animations.

4. The system of claim 1, wherein the information elements comprise textual data.

5. The system of claim 1, wherein the information elements comprise audio data.

6. The system of claim 1, wherein the information elements comprise video data.

7. The system of claim 1, wherein the information elements comprise English language characters.

8. The system of claim 1, wherein one of the elements comprises a word.

9. The system of claim 1, wherein one of the elements comprises a phrase.

10. The system of claim 1, wherein the system comprises a cellular telephone.

11. The system as in claim 1, wherein the association unit is further adapted to generate a new sign language symbol for an element received more than once and which is not associated with a known sign language symbol.

12. A method for visually communicating information to the hearing impaired comprising:
associating each information element with its known sign language symbol; and
generating a new sign language symbol for each element not associated with a known sign language symbol, wherein each element not associated with a known sign language symbol is weighted according to its contribution to the overall meaning of the information to be communicated.

13. The method as in claim 12, further comprising displaying the known and new sign language symbols.

14. The method of claim 12, wherein the known and new sign language symbols comprise animations.

15. The method of claim 12, wherein the information elements comprise textual data.

16. The method of claim 12, wherein the information elements comprise audio data.

17. The method of claim 12, wherein the information elements comprise video data.

18. The method of claim 12, wherein the information elements comprise English language characters.

19. The method of claim 12, wherein one of the elements comprises a word.

20. The method of claim 12, wherein one of the elements comprises a phrase.

21. The method as in claim 12 further comprising generating a new sign language symbol for an element that is received more than once and is not associated with a known sign language symbol.
